(19) United States
(12) Patent Application Publication
(10) Pub. No.: US 2009/0144080 A1
(43) Pub. Date: Jun. 4, 2009

(54) Digital Fitness Enhancement Method and Apparatus

(76) Inventors: Robert Gray, Baltimore, MD (US); Tyler Peppel, Rancho Santa Fe, CA (US)

Correspondence Address: GLENN PATENT GROUP, 3475 EDISON WAY, SUITE L, MENLO PARK, CA, 94025, US

(21) Appl. No.: 12/063,983

(22) PCT Filed: Aug. 17, 2006
(86) PCT No.: PCT/US06/32338

§ 371 Date: Jul. 18, 2008

Related U.S. Application Data
(60) Provisional application No. 60/709,626, filed on Aug. 18, 2005.

(51) Int. Cl. G06Q 50/00; G06F 17/00; G06F 3/00; G06Q 30/00

(52) U.S. Cl. 705/2; 700/94; 715/760; 705/27

(57) ABSTRACT

The presently preferred embodiment of the invention provides a digital fitness enhancement system having multiple components, including controlled playback of digital media for fitness training; a data module which acquires real-time training data, such as heart rate, speed, and distance, where the data can be recorded and also used as feedback to control media playback; and a web service (fitpod.com) which provides tools for storage and analysis of personal fitness data, community services for system users, e.g. events, chat, and a bulletin board, and the ability for users to create and share fitness workout and training programs (fitcasts).

### BACKGROUND OF THE INVENTION

1. Technical Field

The invention relates to physical fitness. More particularly, the invention relates to a digital fitness enhancement method and apparatus.

2. Description of the Prior Art

For millions of people, fitness is a lifestyle. Whether they ride a bike, go to a spinning class, walk 10,000 steps a day, run marathons, use a rowing machine, dance, practice yoga, or meditate, they spend thousand of hours staying fit, and hundreds of millions of dollars on club memberships, equipment, media, personal trainers, books, and specialized diets. For millions of people, music is also a lifestyle; and one that is completely compatible with their interests in fitness. Look in any health club or along any running/biking trial and you will see that people love to listen to music, very often using a digital media player, while they work out. It is no surprise that many music lovers use their digital media players and Macs or PCs to create soundtracks for their workout routines, and that they share favorite play lists with friends and team members. However, there is as yet no way to integrate the progress and intensity of a workout with a music play list, other than preparing a play list prior to a workout, or manually creating play list during a workout by selecting music as the workout proceeds.

### SUMMARY OF THE INVENTION

The presently preferred embodiment of the invention provides a digital fitness enhancement system having multiple components, including controlled playback of digital media for fitness training; a data module which acquires real-time training data, such as heart rate, speed, and distance, where the data can be recorded and also used as feedback to control media playback; and a web service (fitpod.com) which provides tools for storage and analysis of personal fitness data, community services for system users, e.g. events, chat, and a bulletin board, and the ability for users to create and share fitness workout and training programs (fitCasts, fitLists and fitMixes).

### BRIEF DESCRIPTION OF THE DRAWINGS

FIG. 1 is a flow diagram showing a digital fitness enhancement program according to the invention;

FIG. 2 is a block schematic diagram showing a digital fitness enhancement system according to the invention;

FIG. 3 is an architectural flow diagram showing a digital fitness enhancement method and apparatus according to the invention;

FIGS. 4a-4d provide a block schematic diagram showing a digital fitness enhancement architecture according to the invention;

FIG. 5 is a flow diagram showing a workout progression according to the invention; and

FIG. 6 is a screen shot of a fitness website in accordance with the invention.

### DETAILED DESCRIPTION OF THE INVENTION

The presently preferred embodiment of the invention provides a digital fitness enhancement system (DFES) having multiple components, including controlled playback of digital media for fitness training; a data module which acquires real-time training data, such as heart rate, speed, and distance, where the data can be recorded and also used as feedback to control media playback; and a web service (fitpod.com) which provides tools for storage and analysis of personal fitness data, community services for system users, e.g. events, chat, and a bulletin board, and the ability for users to create and share fitness workout and training media (fitCasts, fitLists, and fitMixes).

DFES integrates fitness programming with one of the most popular platforms for personal enjoyment today, the digital media player, to create an entirely new kind of fitness and music experience. By providing a platform for users to design and control how they integrate digital music and media into their personal fitness activities, DFES represents a new and powerful application for digital media and the digital media player platform with features that are indispensable to millions of people who love music and lead an active lifestyle.

The (DFES) is an integrated system for controlling digital media playback to enhance physical or mental well-being. Using a media player, a data module that works with the media player to collect and control physical data based on user determined criteria, offline software tools for manipulating data on a host computer, and an online resource for expanded data manipulation, DFES community building, and related commercial activity, DFES provides a highly customizable, user-based approach to improving and enhancing personal physical and mental well-being.

### DEFINITIONS

Table 1. below provides a list of definitions for various terms used in this document.

TABLE 1
Definitions

| Term | Definition |
|---|---|
| Digital Fitness | A system comprised of all the elements |
| Enhancement System | described below. |
| (DFES) | |
| Fitness Programs | A structured digital media presentation |
| | meant to support/enhance physical health |
| | and well being. A fitness program includes |
| | but is not limited to: scripts, pointers, and |
| | media. Three types of fitness programs are |
| | referred to in this document: |
| | FitCasts: (fitness broadcasts) which are |
| | similar in structure to radio and television |
| | programs. Example: a 30 minute audio |
| | discussion of marathon training tips. |
| | FitLists: (fitness playlists) which are |
| | structured lists of digital media metadata. |
| | Example: A list of suggested song titles to |
| | listen to while running. |
| | FitMixes: (fitness mixes) pre-made |
| | programs of digital media. Example: a one- |
| | hour program containing several pieces of |
| | music designed to enhance the experience |
| | of doing yoga. |
| DFES.com | The DFES website is a online destination |
| | created to provide access to all the parts of |
| | DFES, as well as DFES-related resources. |
| | It includes but is not limited to tools, |
| | utilities, media, educational and marketing |
| | materials, libraries of DFES Programs, |
| | FitLists and Fitcasts, online community |
| | resources, and an online store. |
| Online Toolkit | The DFES toolkit is a group of online |
| | software programs, utilities, and applications |
| | that support the DFES. |
| Data Module | A DFES data module is a hardware and |
| | software device that supports the DFES. |
| | DFES Data Module functions include but |
| | are not limited to: data acquisition, data |
| | recording, data processing, and data |
| | transmission. |
| Offline Toolkit | Resident on a local computing device, the |
| | DFES offline toolkit provides local resources |
| | for access to, creation of, and playback of |
| | DFES Programs and Fitcasts, as well as |
| | management of data I/O between the DFES |
| | Data Module(s), the DFES Website, and the |
| | DFES Media Player |
| Media Player | A DFES or third party product, the functions |
| | of which include but are not limited to the |
| | playback of digital media under control of |
| | the DFES. |

### Digital Fitness Enhancement System (DFES)

DFES begins with a simple idea: the rhythms of music have the power to move and motivate.

DFES enhances the mix of music and fitness by adding personalized control to one of the most popular platforms for personal enjoyment today, the digital media player, to create an entirely new kind of fitness experience. DFES can help anyone with a digital media player attain any individual fitness goal, from physical therapy and quiet meditation to fitness workouts and professional athletic training.

DFES allows users to:
Join an online community of fellow DFES members at DFES.com
Use DFES Data Modules—add-on devices for digital media players that record data such as heart rate, workout pace and duration, and calories burned. It can also control music playback tempo to optimize workout results.
Create and share DFES fitLists (fitness play lists) that synchronize music playback with target performance levels. DFES fitLists can be created for any fitness activity, using music from any genre, providing an endless number of possible fitness/music combinations.
Use DFES tools—a variety of software applications that integrate digital music into the fitness experience. For example, one DFES tool scans a member's music library and assigns beats-per-minute (BPM) to each track. Another DFES tool automatically sorts and matches the BPM of the tracks to desired exercise styles: cardio, fat burn, endurance, etc. Software for identifying the BPM is readily available, such as DJ BPM (http://www.accsi.com/bpm/index.html). One embodiment of the invention uses such BPM information to control a digital media player.
Create and share DFES fitCasts (fitness podcasts) that combine radio-style audio commentary (coaching, fitness reporting, tips and tricks) with DFES fitLists. DFES fitCasts (and DFES fitLists) can be created and shared online by everyone from fitness experts to regular DFES.com members.

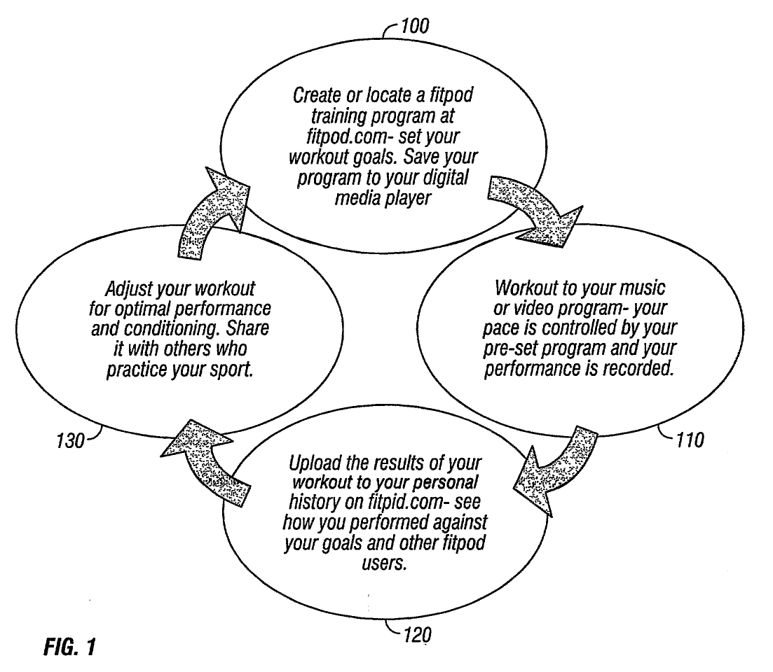

FIG. 1 is a flow diagram showing a digital fitness enhancement program according to the invention. In FIG. 1, an individual creates or locates a fitpod training program at the fitpod.com website. The user sets his training goals and saves the program to a digital media player (100).

The user works out to the music or video program on the digital media player. During the workout, the pace of the workout is controlled by the user's preset program and the user's performance is recorded (110).

The user uploads the results of the workout to a personal history on the fitpod.com website and can see how well he performed against his own goals and against other fitpod users (120).

The user can then adjust his workout for optimal performance and conditioning, as well as share it with others who practice the same sport (130).

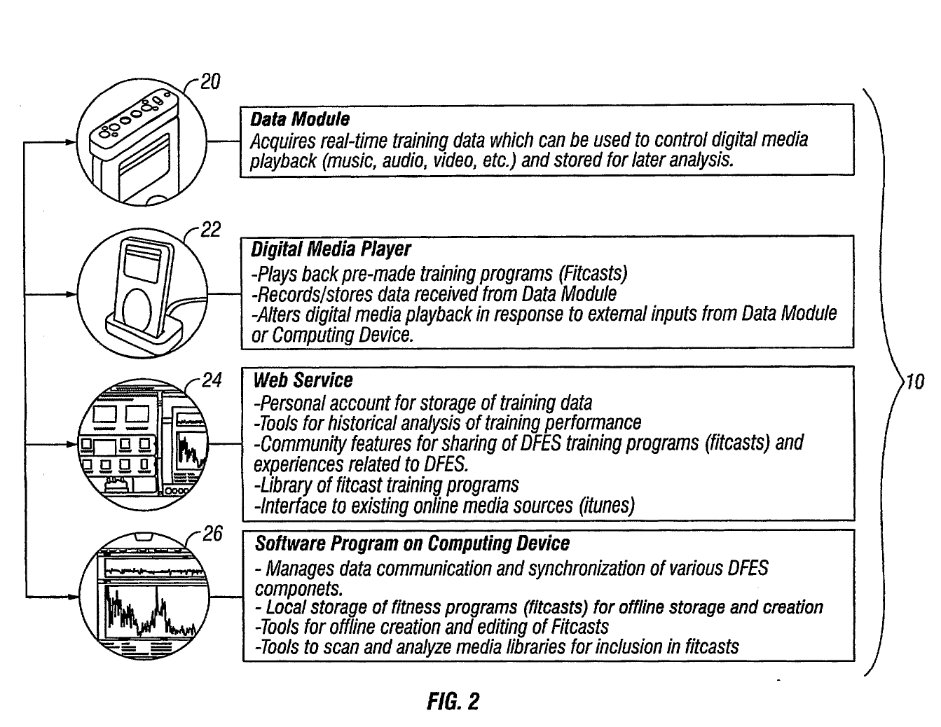

FIG. 2 is a block schematic diagram showing a digital fitness enhancement system according to the invention. The program depicted in FIG. 1 is implemented in the DFES system, which comprises at least:
A data module 20, which is an add-on device for a digital media player that records data such as heart rate, workout pace and duration, and calories burned, as well as controlling music playback tempo to optimize workout results;
A digital media player 22, which is typically a readily available device, such as an Apple iPod, the plays back pre-made training programs (Fitcasts), records and stores data received from the data module, and alters digital media playback in response to external inputs from the data module. Such devices have known interfaces that allow for the integration of the invention therewith. For example, the Apple iPod has a well known interface that is commonly used to integrate the iPod into automobile media systems. A preferred embodiment of the invention uses such interface to integrate the data module therewith to control the presentation of media to a user during a workout;
A web service 24, which is an online destination that provides access to all the parts of DFES, as well as DFES-related resources, and which includes but is not limited to tools, utilities, media, educational and marketing materials, libraries of DFES Programs and Fitcasts, online community resources, and an online store.
A software program on a computing device 26, which manages data communications and synchronization of various DFES components; provides local storage of fitness programs (Fitcasts, FitMixes and FitLists) for offline storage and creation; provides tools for offline creation and editing of Fitcasts; and provides tools to scan and analyze media libraries, such as Apple's itunes music store, for inclusion in Fitcasts.

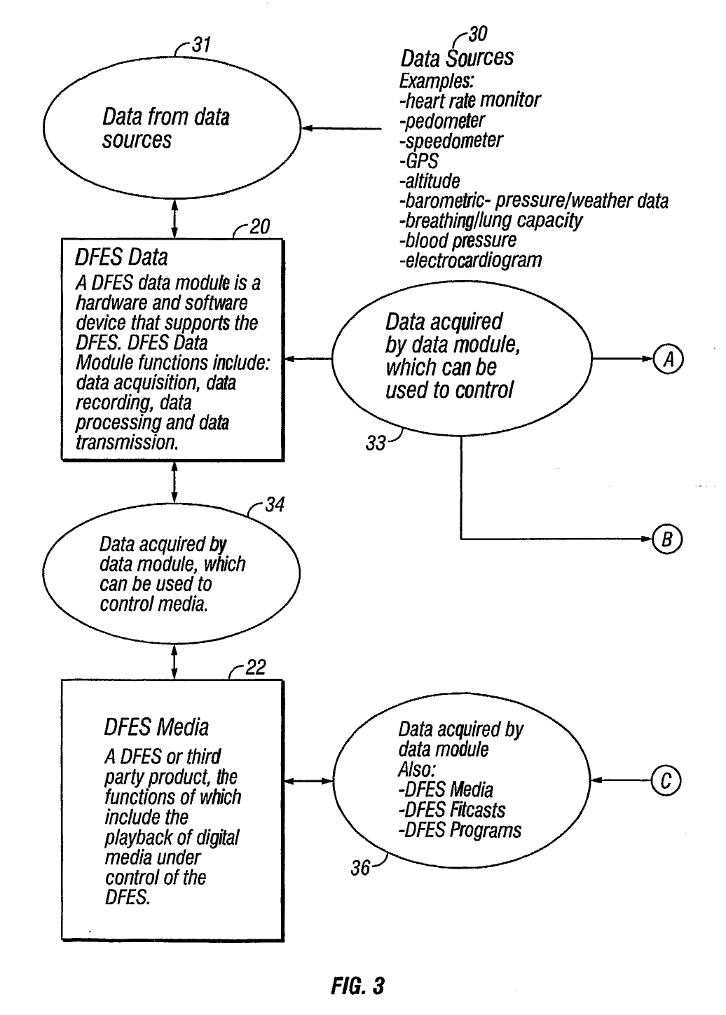

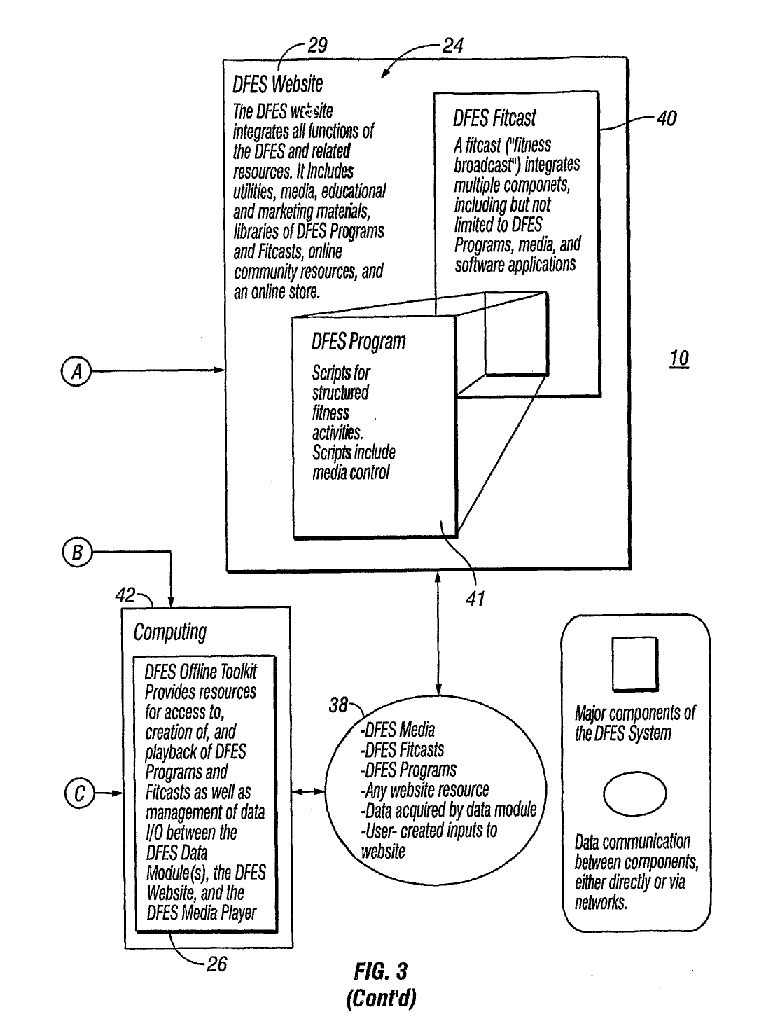

FIG. 3 is an architectural flow diagram showing a digital fitness enhancement method and apparatus according to the invention. In FIG. 3, major system components are shown within a rectangle, while data communications are shown within an oval. The DFES system 10 comprises a data module 20, a digital media player 22, a web service 24, and a computing device 42 on which system software programs 26 are executed. The data module 20 receives data from data sources 31, which may comprise, for example, such data sources 30 as a heart rate monitor, a pedometer, a speedometer, a GPS system, an altimeter, a barometer, breathing measurements, blood pressure measurements, and ECG data. These data are used by the data module to control 33 the web service 24 and software 26. The data module itself comprises a hardware/software device that performs such functions as data acquisition, data recording, data processing, and data transmission. The data module may have a form factor that allows it to mateinterface with a digital media player, for example plugging into the data port of an ipod. In this way, the data module may control operation of the digital media player in accordance with the data received from the various data sources. Thus, one aspect of the invention allows data acquired by the data module to control the presentation of media 34, such as the order and/or pacing of media presentation, based upon such factors as tempo, mood, and the like.

The digital media player provides data acquired by the data module, such as media data, fitcast data, and programs 36, to a computing device 42, such as a user PC or Macintosh computer, for use with the system software programs 26. Such programs include, for example, an offline toolkit that provides access to, creation of, and playback of programs and fitcasts, as well as management of data I/O between the data module 20, web service 24, and media player 22.

The web service 24 comprises a website 29, a fitcast component 40, and a system program 41. The web service communicates 33 with the data module and also communicates 38 with the computing device. In the latter case, data exchanged include media, fitcasts, programs, data acquired by the data module, and user created inputs. The web service provides a website that integrates all functions of the system and related resources. This includes utilities, media, educational and marketing materials, libraries of programs and fitcasts, online community resources, and an online store. The fitcast component of the web service integrates multiple components including, for example. programs, media, and software applications. The system program include3 such components as scripts for structured fitness activities, e.g. scripts that control media presentation.

### Digital Fitness Enhancement System (DFES)—Features and Functions

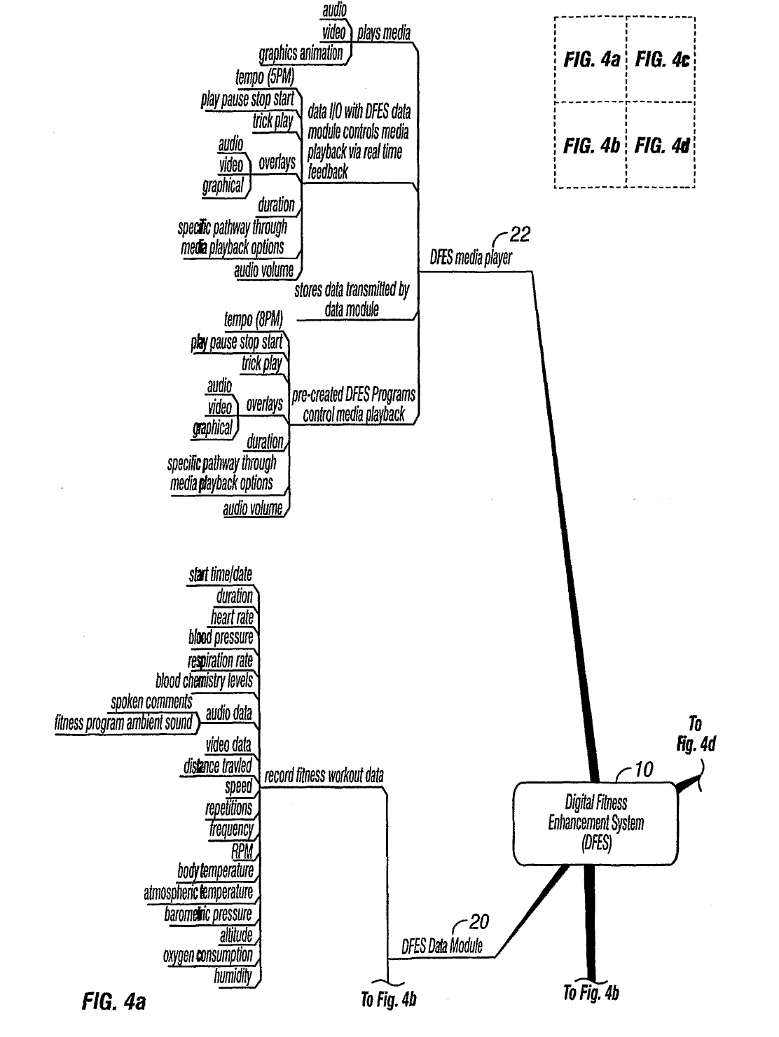

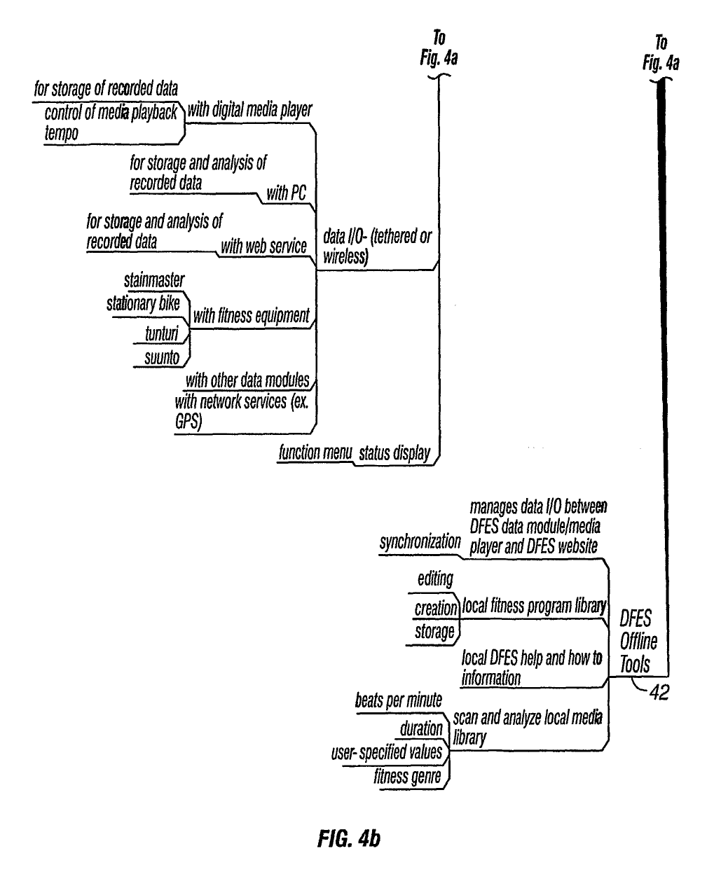

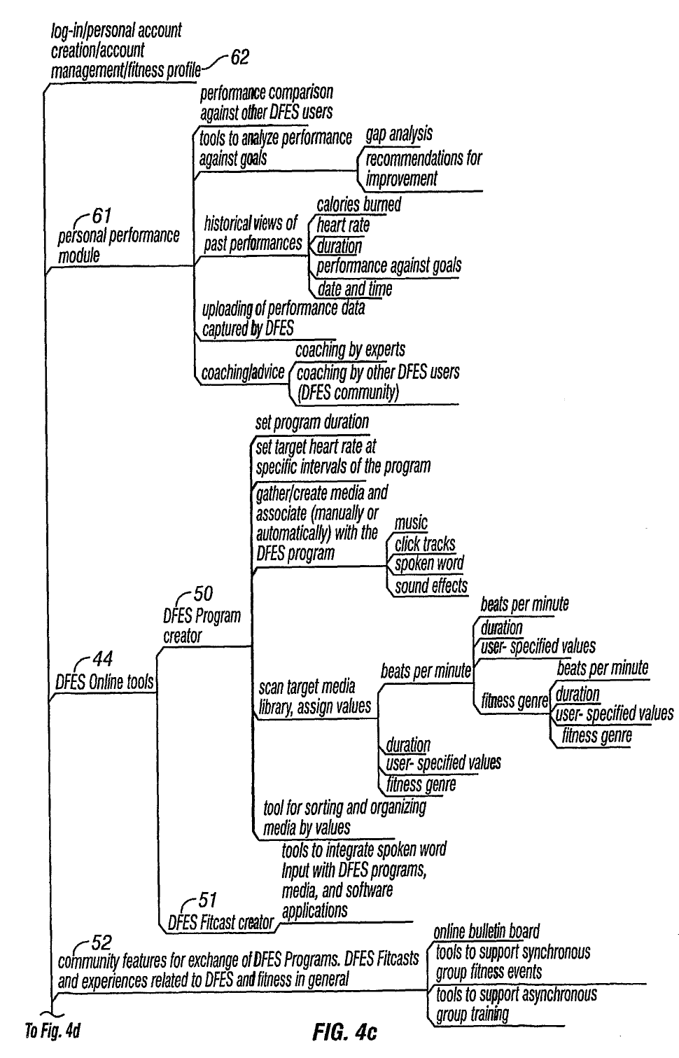

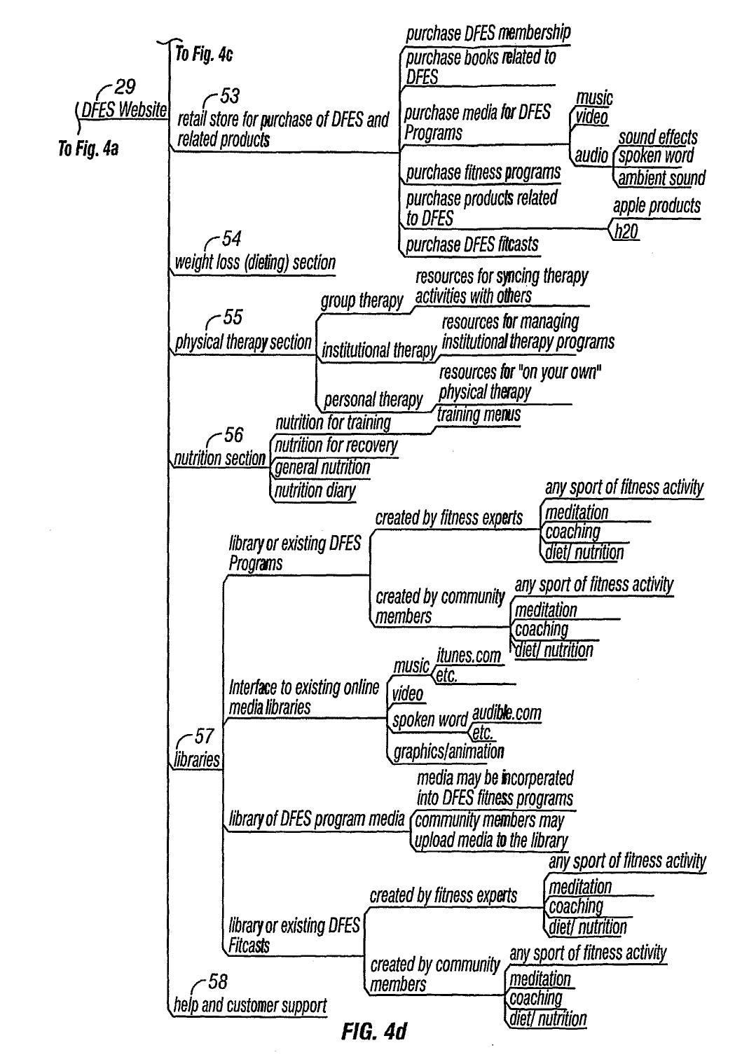

FIGS. 4a-4d provide a block schematic diagram showing a digital fitness enhancement architecture according to the invention. A legend is provided on FIG. 4a which shows the organization of FIGS. 4a-4d.

Media Player 22. A DFES or third party product, the functions of which include but are not limited to the playback of digital media which can be under control of a DFES Program or the DFES Data Module. Features include:

Media Playback
music
video
audio
sound effects
spoken word
graphics/animation
ambient sound

Data I/O with data module controls media playback via real time feedback.
Controls include:
tempo (BPM)
play pause stop start
trick play
overlays
   audio
   video
   graphical
duration
specific pathway through media playback options
audio volume

The Media Player can store data transmitted by the data module

Programs can control media playback. Controls include:
tempo (BPM)
play-pause-stop-start
trick play
overlays
   audio
   video
   graphical
duration
specific pathway through media playback options
audio volume

Data Module 20. The data module is a hardware and software device that supports the DFES system. The Data Module functions include but are not limited to: data acquisition, data recording, data processing and data transmission. Examples of data types that might be acquired, recorded, or transmitted include:
start time/date
duration
heart rate
blood pressure
respiration rate
blood chemistry levels
audio data
spoken comments
fitness activity ambient sound
video data
distance traveled
speed
repetitions
frequency
RPM
body temperature
ambient temperature
barometric pressure
altitude
oxygen consumption
humidity

The Data Module has data I/O features—(tethered or wireless)
for storage of recorded data
for control of media playback
with a computing device
for storage and analysis of recorded data
with the website
for storage and analysis of recorded data
with fitness equipment
any fitness equipment with compatible data I/O
with other data modules
with network services
data broadcasts
GPS
cellular networks

The Data Module includes a status display
function menu

Offline Tools 42. Resident on a local computing device, the offline tools provide local resources for access to, creation of, and playback of Programs and Fitcasts, as well as synchronization and management of data I/O between the Data Module(s), the Website, and the Media Player. Features of the offline tools include:

Local fitness program and Fitcast library and tools for:
editing
creation
storage

### of Fitness Programs and Fitcasts

Local help and how-to information

Tools to scan and analyze local media library by:
beats per minute
duration
fitness genre
user-specified values

Website 29. The website is an online destination created to provide access to all the parts of the system, as well as system-related resources. It includes but is not limited to tools, utilities, media, educational and marketing materials, libraries of Programs and Fitcasts, online community resources, and an online store.

Log-in/personal account creation/account management/fitness profile 60. These features support personalized and customized presentation of website features to website users.

Personal performance module 61. Online resource for recording and analysis of fitness activity performance against goals.

Performance comparison against other system users. Online resource for recording and analysis of fitness activity performance in comparison to other users.

Historical views of past performance. Support understanding of performance progress and goal-setting. Relevant data include:
calories burned
heart rate
duration
performance against goals
date and time

Uploading of performance data captured by the Data Module. Data captured by the Data Module can be uploaded to the website

Coaching/advice. Media resources include coaching by experts and coaching by other system users (DFES community)

Online tools 44. Tools to analyze performance against goals. Interactive features support gap analysis and recommendations for improvement

Program creator 50. A Program is a software program which integrates Fitness Activity with controlled media playback. For purposes of this definition, a Fitness Activity is a structured description of any activity which enhances physical or mental well-being. A program includes but is not limited to: scripts, pointers, and media. The program creator includes such features as: set program duration, set and revise target heart rate, tempo, BPM at specific intervals in the program, and a feature that gathers/creates media and associates it (manually or automatically) with a given program. Such media types include:
music
click tracks
spoken word audio
sound effects
video

Another feature of the program creator is the ability to scan a target media library and assign values, such as:
beats per minute
duration
fitness genre
user-specified values

In addition, custom user-specified values maybe be created and used.

Another Feature of the Program Creator is a tool for sorting and organizing media by values. Its features include:
search by value
sort into groups by value
integrate into the DFES Program by value

Fitcast creator 51. A Fitcast (“fitness broadcast”) integrates multiple components, including but not limited to Programs, media, and software applications into a structured fitness enhancement presentation. The Fitcast Creator features include: tools to create, preview, and present a structured media framework for programs, media, and software applications.

The website includes community features 52 for exchange of Programs, Fitcasts and experiences related to the system and fitness in general. These community features include:
online bulletin board
tools to support synchronous group fitness events
tools to support asynchronous group training

Online Retail Store 53. The Website includes an online retail store for purchase of the system and related products:
purchase system membership
purchase books related to the system
purchase media for DFES Programs:
   music
   video
   audio
   sound effects
   spoken word
   ambient sound
purchase fitness programs
purchase products related to the system from third-party vendors
purchase fitcasts

Dieting Section 54. The website includes a weight loss (dieting) section with resources to help users lose weight:
Dieting Fitcasts
Dieting Programs

Physical therapy Section 55. The website includes a physical therapy section with resources to help users undergoing various types of physical therapy:
group therapy: resources for syncing therapy activities with others
institutional therapy: resources for managing institutional therapy programs
personal therapy: resources for “on your own” physical therapy

Nutrition Section 56. The website contains a library of existing Programs for purchase, download, and free trial use:
nutrition for training
training menus
nutrition for recovery
general nutrition
nutrition diary

Website libraries 57. The Website includes libraries and interfaces to libraries of online resources to support system users. These include:

Library of existing Programs. The website contains a library of existing Programs for purchase, download, and free trial use:
created by fitness experts
any sport or fitness activity
meditation
coaching
diet/nutrition
created by community members

Interfaces to existing online media libraries. The website contains interfaces to online sources for system-compatible media for purchase, download, and free trial use:
music
video
audio
sound effects
spoken word
graphics/animation
ambient sound

Library of system-compatible media. The Website includes a library of system-compatible media may be incorporated into system fitness programs.

System Users may upload media to the library. Media types include:
music
video
audio
sound effects
spoken word
graphics/animation
ambient sound

The Website includes a library of existing Fitcasts created by fitness experts or community members:
for any sport or fitness activity
meditation
coaching
diet/nutrition

The Website includes a help and customer support section 58.

### A Day in the Life of DFES

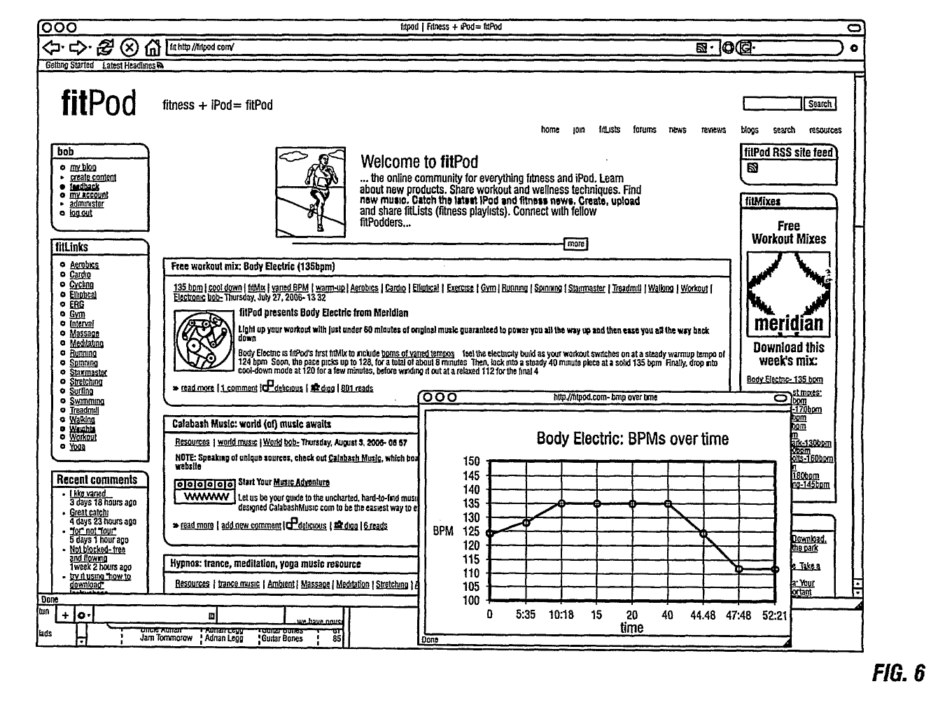

### (For Example, See FIG. 6)

Tom rises early for his morning training session. He is a cycling enthusiast who spends the off-season training indoors on a stationary bike. While having his pre-workout fitness shake, he checks his account at DFES.com. He notes that a new DFES fitList, a DFES fitness program, has automatically been added overnight to his member folder on DFES.com. Tom subscribes to several member services on DFES.com that automatically update his account with DFES fitLists for his favorite fitness activities.

Automatic updates are one of the benefits of Tom's $5.00 monthly membership fee at DFES.com. Some features of DFES.com are free, others such as the ability to create and share DFES fitLists, come with paid membership.

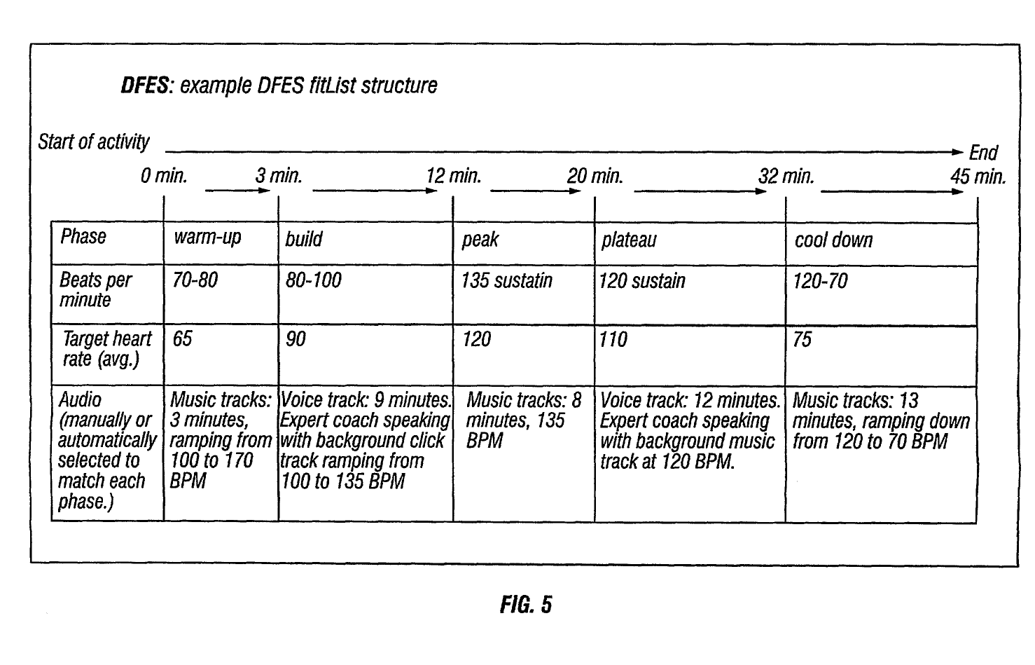

Using online tools at DFES.com, Tom regularly creates DFES fitLists based on his own training experiences. A simple interface lets Tom set up the basic parameters of the DFES fitList (warm-up, build, peak, plateau, cool down) and duration of each phase. DFES.com has tools to automatically scan Tom's music collection, and assign beats per minute (BPM) to each track. He then associates music of his choosing with each phase of the workout, or he can have DFES.com automatically suggest music tracks, based on BPM and/or duration (see FIG. 5).

As a cyclist, Tom has fun creating DFES fitLists and giving them names such as “Disco Spinout” (for sustained spinning), “High-altitude Electronica” (for simulating mountainous road biking), and “Hardcore Interval” (for interval training). As with most digital music enthusiasts, he loves listening to his music library randomly, and often lets DFES create fitLists based on random selections from his music library that fit his workout style. Some of these turn out so well that he names and uploads them to DFES.com for sharing. Tom takes satisfaction from seeing his work recognized and used by other members of the DFES community.

Tom notices that other DFES members have downloaded DFES fitLists he has created 1,722 times in the last 24 hours. The DFES.com front-page ratings show that his DFES fitLists are in the top 25 download rankings worldwide. He vows to create some new DFES fitLists to push his ranking into the Top Ten.

While Tom enjoys creating DFES fitLists, many members are content simply to browse and download from the existing DFES fitList libraries. There are DFES fitList libraries for every imaginable fitness activity: running, spinning, rowing, swimming, Stairmaster, aerobics, dance, weight training, and even walking.

Tom's paid membership allows him to search and download from the DFES fitList library by any number of criteria. He can search DFES fitLists by:
sport or fitness activity
musical genre
DFES fitList creator/creation date
level of ability (beginner, intermediate, etc.)
DFES fitLists which use music or audio he already owns
DFES fitLists designed to be used in a specific location (i.e. running in London's Hyde Park)
DFES fitLists that simulate specific locations (i.e. The 2005 Tour de France series)
DFES fitLists that contain a particular song

When Tom finds a DFES fitList he wants, DFES.com tells him how many of the DFES fitList's music tracks he already has, and if needed, presents him with a simple interface to purchase the additional tracks used in the DFES fitList. He can also use the BPM settings from an existing DFES fitList as a template and have DFES create a new DFES fitList from his music library that pairs his music with the pre-existing BPM settings.

Tom also notices that he has new messages from other members. A “member search” function on DFES.com makes it easy for Tom to find and connect online with members who share his fitness goals and abilities. They use DFES.com to share DFES fitLists, organize group training events, share tips, start online clubs, and give each other encouragement to meet their fitness goals.

Some members also write blogs at DFES.com about their training experiences, and members also create “DFES fitCasts,” (fitness-related podcasts). DFES fitCast content runs the gamut from coaching and training tips to equipment reviews, lectures on positive thinking, and reporting from sports events. DFES fitCasts can also incorporate and refer to DFES fitLists. When a member downloads a DFES fitCast that refers to a DFES fitList, the related DFES fitList is automatically downloaded as well.

Tom takes his digital media player from the dock that connects it to his PC and plugs in a small device, a “DFES/mod.” “Mod” is short for “Data Module,” an optional add-on to his digital media player that picks up and records various real-time fitness parameters such as heart rate, workout duration, calories burned, time of day, etc. The Mod is designed in a style similar to Tom's digital media player; at first glance, it is barely noticeable. Tom puts on his digital media player, plugs in his headphones, straps on his heart rate monitor, and he's ready to go.

This morning's stationary bike ride will last 45 minutes. At the starting point, Tom selects the morning's DFES fitList (Number 7 in a series of 12 specifically designed to boost endurance) and hits “play” on his digital media player. He glides through the phases of his workout to the beat of his favorite tunes, moving to the music playing on his digital media player. At certain moments in his workout, the music fades and he hears a coach's voice introducing the next phase of the workout and offering some words of encouragement.

As Tom rides, the Data Module records his heart rate in real time. As an option, Tom can turn on the “feedback” feature on the Data Module, which compares actual heart rate to the target heart rate specified in his DFES fitList. If his heart rate varies significantly from the target rate, the Data Module adjusts the audio playback tempo accordingly, until his actual heart rate reaches the DFES fitList target rate. For safety reasons, Tom does not listen to music when out on the road. However, he does use the Data Module's data capture capabilities to record valuable ride data, just as when he's training indoors.

After finishing his workout, Tom docks his digital media player/Data Module with his PC and heads to the shower. Meanwhile, Tom's DFES.com account automatically syncs with Tom's digital media player/Data Module and uploads the data captured during Tom's workout to his member account.

When Tom returns to his PC, his is presented with a detailed graph showing his performance against his targets for the day along with a chart showing performance for Ride 7 in the context of past performance in Rides 1 through 6. He can also display a custom graph showing his performance compared to other DFES members who have done the same workout (“Team Fortitude”), some of them on this same morning, in other parts of the world. Tom can quickly type in comments and encouragement to fellow Team Fortitude members and see their comments in turn.

Team Fortitude, many of whom met online at DFES.com, is planning to gather next summer for a three-week bike tour through the Adirondacks using a route and maps that Tom downloaded from the Radical Rides section of the DFES.com website.

Tom's girlfriend Alicia is a musician and a DFES.com member as well. She's not a hardcore cyclist as is Tom, but she's dedicated to staying in shape. She belongs to a local all-girl athletic club, where she does spinning, aerobics, and rowing. She's discovered that DFES makes the music she composes on her computer adaptable for use in fitness activities, and she has begun creating music for DFES fitLists designed for different fitness activities. She's found that hip-hop dance rhythms are great for spinning, and the pop music anthems she's been creating for years are great for aerobics. Accidentally, she discovered the reggae tunes she's experimenting with work great with rowing, especially when she increases the tempo just a couple of clicks.

Her enthusiasm for creating fitness music really picked up when she learned that DFES.com provides a marketplace for the fitness music she composes: she can upload and sell her work at DFES.com.

Alicia takes her DFES/Data Module to the club and uses it to enhance her workouts. When she showed it to Jane, the club aerobics instructor, Jane went online to DFES.com and quickly realized that she could become a personal trainer to thousands of DFES members. She joined DFES.com and started creating DFES fitLists of her favorite aerobics workouts, some using newly-composed music from Alicia.

Jane has also started publishing DFES fitCasts of tips on preventing injury while maximizing workout effects, the mental benefits of aerobics, nutrition and aerobics, and more. Jane is designing a DFES aerobics group that combines in-person group workouts at the club with the unique enhancements available only to DFES users. And she's bringing new business into the club.

Tom and Alicia recently discovered a “couple's workout” area on DFES.com with DFES fitLists designed especially for couples. This area has DFES fitLists for a wide variety of sports, including some that are intimate in nature. Tom is eagerly awaiting the delivery of a small adapter he ordered that will allow him and Alicia to each plug their headphones into a single digital media player, thus allowing a high degree of synchronization in the timing and pacing of their movements. Tom has some ideas for some specific couple's DFES fitLists he would like to create that he thinks could be very popular, with music by Alicia, of course.

Tom's mother Lucy is a physical therapist with a lifelong interest in healthy living. For her 60^{th} birthday, Tom bought her a digital media player so she would quit borrowing his all the time. This year, he bought her a DFES.com membership. He knew that with her interests in nutrition, wellness, and meditation, she would be able to take advantage of features of DFES.com he has seen at the website, but hasn't explored himself.

Lucy wastes no time discovering the active meditation community on DFES.com, where DFES fitLists of ambient music, DFES fitCasts of dharma discussions from meditation leaders, and discussion boards for massage therapists, yoga teachers, and meditation groups provide a rich environment for exploration and personal fulfillment. Much as Tom uses DFES fitLists to guide him through his workouts, Lucy uses DFES fitLists to guide her through meditation practice. She listens to DFES fitCasts on the practice of mindfulness meditation as she drives to work, and she meets others who share her interest in the healing properties of meditation through a DFES.com blog.

Lucy has also recently discovered the nutrition area of DFES.com, where DFES fitCasts on healthy eating are paired with suggested menus. She got Tom interested in that, and now, he's applying DFES.com's nutrition resources to his own training menu.

Lucy's interest in DFES is not purely personal. As a healthcare professional, she quickly saw DFES's potential as a therapeutic aid to her physical therapy patients. She is working with Dr. Jennings, (a cardiovascular physician who practices at her clinic) to design a study on how the DFES system can be used with patients to improve therapeutic regimes—to extend the benefit of onsite physical therapy to day-to-day, patient controlled exercise and therapy. The clinic has purchased 100 DFES.com memberships and digital media player/Data Modules for the study.

Lucy and the Dr. Jennings plan to publish the results of their findings early next year. In a follow-up study, they plan to explore how DFES can be integrated into corporate employee wellness programs. They believe that DFES-mediated wellness programs can enhance employee fitness, thereby reducing workplace injuries and absenteeism and increasing productivity. They have contacted a local major corporation as a potential site for the study. They have also completed a draft proposal of the plan for submission to its insurance provider. The goal is for employers to be able to negotiate reduced health insurance premiums in exchange for offering DFES-based wellness programs to their employees.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A digital fitness enhancement apparatus, comprising:
a data module for acquiring real-time or previously prepared training data, wherein said data are used for real time, controlled playback of digital media during fitness training; and
a digital media player, associated with said data module, for playing back said digital media in accordance with said training data.

2. The apparatus of claim 1, further comprising:
a web service for providing any of the following:
tools for storage and analysis of personal fitness data acquired via said data module;
community services for system users; and
a facility that allows users to create and share fitness workout and training programs.

3. A digital fitness enhancement method, comprising the steps of:
providing a fitness website at which an individual creates or locates at least one training program;
providing tools at said website with which said user can access training goals and save said training program to a data module associated with a digital media player;
while said user is working out to digital content on said digital media player, said data module controlling the pace of said workout in real time with said user's training program based upon at least one signal that is representative of said user's performance; and
recording parameters of said user's performance.

4. The method of claim 3, further comprising the step of:
uploading the results of the workout to a personal history on the fitness website.

5. A digital fitness enhancement apparatus, comprising:
a data module for recording user performance data during a workout, said data module controlling media playback tempo in real time in response to at least one signal that is representative of said user's performance to optimize workout results; and
a digital media player, associated with said data module, for playing back pre-made training programs, recording and storing data received from said data module, and altering digital media playback in response to external inputs from said data module.

6. The apparatus of claim 5, further comprising:
a web service that communicates with said data module and/or with a computing device, for providing access to any of tools, utilities, media, educational and marketing materials, libraries of workout programs, online community resources, and an online store.

7. The apparatus of claim 6, further comprising:
a software program for execution on a computing device, said software program managing data communications and synchronization of said data module; providing local storage of fitness programs for offline storage and creation; providing tools for offline creation and editing of workout programs; and providing tools to scan and analyze media libraries for inclusion in workout programs.

8. The apparatus of claim 5, wherein said data module comprises an add-on device for said digital media player.

9. The apparatus of claim 5, said performance data comprising any of heart rate, workout pace and duration, and calories burned, as well as any of data from data sources such as a heart rate monitor, a pedometer, a speedometer, a GPS system, an altimeter, a barometer, breathing measurements, blood pressure measurements, and ECG data.

10. The apparatus of claim 7, wherein said user performance data are used by said data module to control said web service and said software program.

11. The apparatus of claim 7, said digital media player further comprising any of:
means for media playback of any of music, video, audio, sound effects, spoken word, graphics/animation, and ambient sound;
data I/O means by which any of said data module and said software program controls media playback via real time feedback, wherein said controls comprise any of tempo (BPM), play pause stop start, trick play, any of audio, video, and graphical overlays, duration, a specific pathway through media playback options, and audio volume; and
means for storing data transmitted by said data module.

12. The apparatus of claim 7, said data module further comprising any of:
means for any of data acquisition, data recording, data processing, and data transmission, said data types that can be acquired, recorded, or transmitted comprising any of start time/date, duration, heart rate, blood pressure, respiration rate, blood chemistry levels, audio data comprising any of spoken comments and fitness activity ambient sounds, video data, distance traveled, speed, repetitions, frequency, RPM, body temperature, ambient temperature, barometric pressure, altitude, oxygen consumption, and humidity;
data I/O means, which are either tethered or wireless, for any of storage of recorded data and control of media playback with any of a computing device for storage and analysis of recorded data, with said website for storage and analysis of recorded data, with fitness equipment, with other data modules, and with network services that comprise any of data broadcasts, GPS, and cellular networks; and
a status display comprising a function menu.

13. The apparatus of claim 7, said software program further comprising:
offline tools, resident on a local computing device, for providing local resources for access to, creation of, and playback of workout programs, as well as synchronization and management of data I/O between said data module, said website, and said media player; said offline tools comprising any of a local fitness program and library and tools for editing, creation, and storage of workout programs, local help and how-to information, tools to scan and analyze local media library by any of beats per minute, duration, fitness genre, and user-specified values.

14. The apparatus of claim 7, said web service further comprising any of:
a log-in/personal account creation/account management/fitness profile for providing personalized and customized presentation of website features to website users;
a personal performance module for recording and analysis of fitness activity performance against goals;
a module for performance comparison against other system users for recording and analysis of fitness activity performance in comparison to other users;
historical views of past performance to support understanding of performance progress and goal-setting, said views comprising data that include any of calories burned, heart rate, duration, performance against goals, and date and time;
means for uploading of performance data captured by said data module;
means for providing coaching/advice coaching by experts and coaching by other system users;
online tools for analyzing performance against goals, including interactive features that support gap analysis and recommendations for improvement;

15. The apparatus of claim 5, further comprising:
a program creator for integrating fitness activity with controlled media playback, wherein fitness activity comprises a structured description of any activity which enhances physical or mental well-being, and wherein a program comprises any of scripts, pointers, and media, said program creator providing functions comprising any of set program duration, set and revise target heart rate, tempo, BPM at specific intervals in said program, and gathering/creating media and associating said media, manually or automatically, with a given program, wherein media types comprise any of music, click tracks, spoken word audio, sound effects, and video.

16. The apparatus of claim 15, said program creator further comprising any of:
means for scanning a target media library and assigning values, said values comprising any of beats per minute, duration, fitness genre, and user-specified values; and
means for creating and using custom user-specified values.

17. The apparatus of claim 15, said program creator further comprising any of:
means for sorting and organizing media by values according to any of search by value, sort into groups by value, and integrate into the program by value.

18. The apparatus of claim 5, further comprising:
a creator for a fitness broadcast that integrates any of programs, media, and software applications into a structured fitness enhancement presentation, said creator features comprising tools for creating, previewing, and presenting a structured media framework for programs, media, and software applications.

19. The apparatus of claim 7, said web service further comprising any of:
a community module for exchanging programs and experiences related to the system and fitness in general, including any of an online bulletin board, tools to support synchronous group fitness events, and tools to support asynchronous group training;
an online retail store for purchasing system and related products, including any of purchasing system membership, purchasing books related to said system, purchase media for programs, including any of music, video, audio, sound effects, spoken words, and ambient sounds, purchasing fitness programs, purchasing products related to the system from third-party vendors, and purchase fitness broadcasts;
a dieting module for providing resources to help users lose weight, including any of dieting fitness broadcasts, and dieting programs;
a physical therapy module for providing resources to help users undergoing various types of physical therapy, including any of group therapy resources for syncing therapy activities with others, institutional therapy resources for managing institutional therapy programs, and personal therapy resources for “on your own” physical therapy;
a nutrition module comprising a library of existing program for purchase, download, and free trial use, including any of nutrition for training, training menus, nutrition for recovery, general nutrition, and a nutrition diary;
website libraries and interfaces to libraries of online resources to support system users, including any of libraries of existing programs for purchase, download, and free trial use, including any of programs created by fitness experts, any sport or fitness activity, meditation, coaching, diet/nutrition, created by community members;
interfaces to existing online media libraries for system-compatible media for purchase, download, and free trial use, including any of music, video, audio, sound effects, spoken word, graphics/animation, and ambient sound;
a library of system-compatible media which may be incorporated into system fitness programs;
means for system users to upload media to said library, media types including any of music, video, audio, sound effects, spoken word, graphics/animation, and ambient sound;
a library of existing fitness broadcast created by fitness experts or community members for any sport or fitness activity, meditation, coaching, and diet/nutrition; and
a help and customer support module.
